(19) United States
(12) Patent Application Publication
(10) Pub. No.: US 2013/0007633 A1
(43) Pub. Date: Jan. 3, 2013

(54) METHOD AND SYSTEM FOR ENHANCING MESSAGE LIST FUNCTIONALITY

(75) Inventors: Ram COHEN, Tel Aviv (IL); Aryeh MERGI, Bazra (IL)

(73) Assignee: ACTIVEPATH LTD., Petah-Tiqva (IL)

(21) Appl. No.: 13/541,017

(22) Filed: Jul. 3, 2012

Related U.S. Application Data
(60) Provisional application No. 61/504,209, filed on Jul. 3, 2011.

(51) Int. Cl. G06F 3/048

(52) U.S. Cl. 715/752

(57) ABSTRACT

Systems, methods, computer program products, and networks for enhancing message list functionality. In some embodiments, a method includes: after a message in a message list has been indicated by a user performing a gesture on an input module manipulating a graphical user interface whose content included the message list so as to enable data, which relates to content of the message, and which was not visible when the user performed the gesture, to be displayed to the user.

### CROSS REFERENCE TO RELATED APPLICATIONS

This application claims the benefit of U.S. Provisional Application No. 61/504,209, filed on Jul. 3, 2011, which is hereby incorporated by reference herein.

### TECHNICAL FIELD

This disclosure relates to the field of messaging.

### BACKGROUND

The message list area of web mail providers and email applications typically includes the message sender name or address, the message subject (or part thereof if the subject is too long), the date the message was sent or received, and perhaps some more information such as total message size and whether or not the message includes attachments.

To the user, this information is typically not enough for assessing the importance and relevance of the message so the user has to click each message item in order to read its content.

Some applications or web sites offer today certain limited functionality when the user places the mouse pointer on top of a message item. This functionality typically includes information and/or activities relating to the message sender such as sending and/or replying to the message. FIG. 1A is a screenshot of what is displayed when a user places a mouse pointer over the message sender information of a message list in Gmail. FIG. 1B is a screenshot of what is displayed when a user places a mouse pointer over the message sender information of a message list in Hotmail.

### SUMMARY

In one aspect, in accordance with the disclosed subject matter there is provided a method, comprising: after a message in a message list has been indicated by a user performing a gesture on an input module, manipulating a graphical user interface whose content included the message list so as to enable data which relates to content of the message and which was not visible when the user performed the gesture to be displayed to the user.

In some embodiments of the method, the manipulating includes: inserting in the graphical user interface at least one graphical user interface element whose content includes data which relates to content of the message and which was not visible when the user performed the gesture. In some of these embodiments, the at least one graphical user interface element includes at least one selected from a group comprising: pop-up window, overlay graphical user interface element, or preview section.

In some embodiments of the method, the manipulating includes: modifying content of at least one existing graphical user interface element in the graphical user interface so as to include data which relates to content of the message and which was not visible when the user performed the gesture. In some of these embodiments, the at least one existing graphical user interface element includes at least one selected from a group comprising: message list area or existing preview section.

In some embodiments of the method, the data which relates to content of the message includes at least one selected from a group comprising: a more detailed message subject than visible when the user performed the gesture, body of the message, part of a body of the message, at least one name of attachment to the message, at least one attachment to the message, updated message content, interactive message content, or a visually enhanced message subject.

In some embodiments, the method further comprises: displaying to the user data which relates to content of the message and which was not visible when the user performed the gesture.

In some embodiments of the method where the message list is included in a webpage, the method further comprises: analyzing the webpage in order to determine an identifier of the message; providing the identifier to a message managing system associated with the webpage; and receiving from the message managing system data which relates to content of the message and which was not visible when the user performed the gesture.

In some embodiments, the method further comprises: determining whether or not the message matches a predetermined criterion; wherein only if the message matches a predetermined criterion, the manipulating occurs, but if the message does not match a predetermined criterion then the manipulating does not occur.

In another aspect, in accordance with the disclosed subject matter there is provided a system, comprising: a manipulator capable of manipulating a graphical user interface whose content included a message list, after a message on the message list has been indicated by a user performing a gesture on an input module, so as to enable data which relates to content of the message and which was not visible when the user performed the gesture to be displayed to the user.

In some embodiments, the system further comprises: a display capable of displaying to the user data which relates to content of the message and which was not visible when the user performed the gesture.

In some embodiments, the system further comprises: a detector capable of detecting that a message in a message list has been indicated by the user performing the gesture.

In some embodiments, the system further comprises: an input capable of having the user indicate the message by performing a gesture thereon.

In some embodiments, the system further comprises: a memory capable of storing data which relates to content of the message and which was not visible when the user performed the gesture.

In some embodiments, the system further comprises: an analyzer capable of analyzing a webpage which included the message list in order to determine an identifier of the message.

In some embodiments, the system is further capable of determining whether or not the message matches a predetermined criterion, wherein only if the message matches a predetermined criterion, the manipulating occurs, but if the message does not match a predetermined criterion then the manipulating does not occur.

In some embodiments, the system is a receiving system.

In some embodiments, the system is a message managing system capable of providing web-based message management to a plurality of users including the user.

In some embodiments, the system includes a receiving system and a message managing system capable of providing web-based message management to a plurality of users including the user.

In some embodiments, the system is included in at least one selected from a group comprising: a web site, a web browser, an instant messaging client, a peer to peer application, a user interface, an SMS application, an MMS application, a messaging application, any other type of Internet client, a plug-in add-on toolbar or applet for a web browser mail client instant messaging client or any other application, a standalone client, any other element servicing one user device, a gateway, a proxy server, any other type of server, a Web service, any other element servicing multiple user devices, or an element with any other suitable configuration.

In another aspect, in accordance with the disclosed subject matter there is provided a computer program product comprising a computer useable medium having computer readable program code embodied therein, the computer program product comprising: computer readable program code for causing the computer, after a message in a message list has been indicated by a user performing a gesture on an input module, to manipulate a graphical user interface whose content included the message list so as to enable data which relates to content of the message and which was not visible when the user performed the gesture to be displayed to the user.

### BRIEF DESCRIPTION OF THE DRAWINGS

In order to understand the subject matter and to see how it may be carried out in practice, embodiments will now be described, by way of non-limiting example only, with reference to the accompanying drawings, in which:

FIG. 1A is a prior art screenshot of what is displayed when a user places a mouse pointer over the message sender information of a message list in Gmail;

FIG. 1B is a prior art screenshot of what is displayed when a user places a mouse pointer over the message sender information of a message list in Hotmail;

FIG. 2 is a functional block diagram of a network for messaging, according to some embodiments of the subject matter;

FIG. 3 is a functional block diagram of a system for enhancing message list functionality, according to some embodiments of the subject matter;

FIG. 4 is a flowchart illustration of a method of enhancing message list functionality, according to some embodiments of the subject matter;

FIG. 5 is a flowchart illustration of a method of enhancing message list functionality, according to some other embodiments of the subject matter;

FIG. 6 is a flowchart illustration of a method of enhancing message list functionality, according to some other embodiments of the subject matter;

FIG. 7A is a screenshot of a Gmail message list before a user performs a gesture on an input device, according to some embodiments of the subject matter; and

FIG. 7B is screenshot of what is displayed after a user indicated a message in a Gmail message list by performing a gesture on an input device, according to some embodiments of the subject matter.

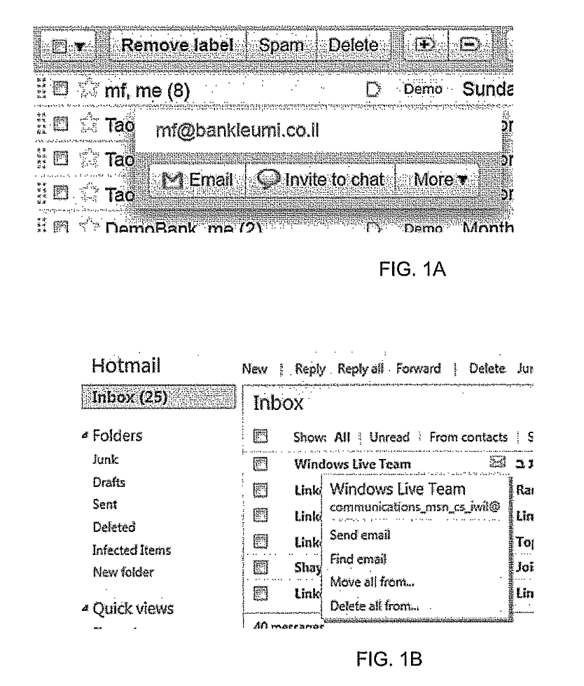

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

Disclosed are some embodiments of systems, methods, networks, and computer programs for enhancing message list functionality.

In the following detailed description, numerous specific details are set forth in order to provide a thorough understanding of the subject matter. However, it will be understood by those skilled in the art that some embodiments of the subject matter may be practiced without these specific details. In other instances, well-known stages, methods, modules, elements, and systems have not been described in detail so as not to obscure the subject matter.

As used herein, and unless explicitly stated otherwise, the term “memory” refers to any module for storing data for the short and/or long term, locally and/or remotely. Examples of memory include inter-alia: any type of disk including floppy disk, hard disk, optical disk, CD-ROMs, magnetic-optical disk, magnetic tape, flash memory, random access memory (RAMs), dynamic random access memory (DRAM), static random access memory (SRAM), read-only memory (ROMs), programmable read only memory PROM, electrically programmable read-only memory (EPROMs), electrically erasable and programmable read only memory (EEPROMs), magnetic card, optical card, any other type of media suitable for storing electronic instructions and capable of being coupled to a system bus, a combination of any of the above, etc.

Usage in the specification of the term “for example,” “such as”, “for instance”, “e.g.”, “possibly”, “optionally”, “say”, “one embodiment”, “one example”, “embodiments”, “examples”, “an embodiment”, “some embodiments”, “various embodiments”, “some examples”, “illustrated embodiments”, “another embodiment”, “another example”, “various examples”, “other embodiments”, “other examples”, “one instance”, “some instances”, “ another instance”, “other instances”, “one case”, “cases”, “some cases”, “another case”, “other cases”, or variants thereof means that a particular described feature, structure or characteristic is included in at least one non-limiting embodiment of the subject matter, but not necessarily included in all embodiments. The appearance of the same term does not necessarily refer to the same embodiment(s).

The term “illustrated embodiments”, is used to direct the attention of the reader to one or more of the figures, but should not be construed as necessarily favoring any embodiment over any other.

It should be appreciated that certain features disclosed herein, which are, for clarity, described in the context of separate embodiments, may also be provided in combination in a single embodiment. Conversely, various features, structures and/or characteristics disclosed herein, which are, for brevity, described in the context of a single embodiment, may also be provided separately or in any suitable sub-combination.

Unless specifically stated otherwise, as apparent from the following discussions, it is appreciated that throughout the specification discussions utilizing terms such as “detecting”, manipulating”, “performing”, “indicating”, “inserting”, “modifying”, “displaying”, “analyzing”, “providing”, “receiving”, “determining”, “caching”, “storing”, “matching”, “causing”, “retrieving”, “sending”, “checking”, “presenting”, “deleting”, “executing”, “allowing”, “using”, “handling”, “enabling”, or the like, refer to the action and/or processes of any combination of software, hardware and/or firmware. For example, these terms may refer in some cases to the action(s) and/or process(es) of one or more computer(s), that manipulate(s) and/or transform(s) data represented as physical, such as electronic quantities, within the registers and/or memories of the computer(s) into other data similarly represented as physical quantities within the memories, registers and/or other such information storage, transmission and/or display element(s) of the computer(s). The term “computer” should be expansively construed to cover any kind of electronic system which includes at least some hardware and has data processing capabilities, even if not labeled as such.

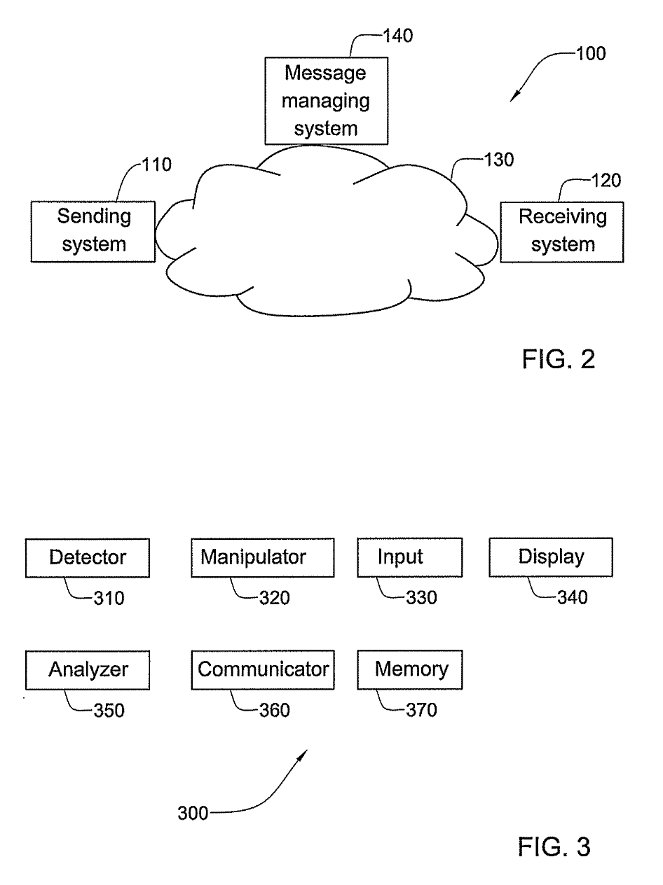

Referring now to the drawings, FIG. 2 illustrates a network 100 for messaging, according to some embodiments of the subject matter. In the illustrated embodiments, network 100 includes one or more sending systems 110 configured to send messages, one or more receiving systems 120 configured to receive messages, one or more communication channels 130 and optionally one or more message managing systems 140 configured to manage messages. Embodiments of the subject matter do not limit the type(s) of messages transferred via network 100. Examples of types of messages may include: email messages (e.g. web-based or email client application based), SMS (“Short Message Service”), MMS (“Multi-media Messaging Service”), social network messages (e.g. Facebook messages, Twitter “tweets”, etc), instant messaging messages, a combination of the above, etc. When included, each sending system 110, receiving system 120, and message managing system 140 may be made up of any combination of hardware, software and/or firmware capable of performing the operations as defined and explained herein. For example, in some embodiments, any of sending system 110, receiving system 120 and/or message managing system 140 may at least partly comprise or be comprised in one or more computer(s) specially constructed for the desired purposes, and/or may at least partly comprise or be comprised in one or more computer(s) selectively activated or reconfigured by specially constructed program code. Additionally or alternatively, in some embodiments, any of sending system 110, receiving system 120 and/or message managing system 140 may comprise at least some hardware. For simplicity of description, sending system 110, receiving system 120, message managing system 140 and communication channel 130 are referred to below in the single form, but such reference should be construed to include embodiments with a single and/or a plural number of system(s)/channel(s), as appropriate for specific implementations and/or particular messages.

Features of sending system 110 may vary depending on the embodiment. For example, in various embodiments part or all of sending system 110 may at least partly include or be included in user device(s) such as personal computer(s), cell phone(s), smartphone(s), laptop(s), tablet computer(s), etc., may at least partly include or be included in element(s) which service multiple user devices such as proxy server(s), gateway(s), other types of servers, etc, and/or may at least partly include or be included in a combination of the above. Depending on the embodiment, modules in sending system 110 may be concentrated in the same location, for example in one unit or in various units in proximity of one another, or modules of sending system 110 may be dispersed over various locations.

Features of receiving system 120 may vary depending on the embodiment. For example, in various embodiments part or all of receiving system 120 may at least partly include or be included in user device(s) such as personal computer(s), cell phone(s), smartphone(s), laptop(s), tablet computer(s), etc., may at least partly include or be included in element(s) which service multiple user devices such as proxy server(s), gateway(s), other types of servers, etc, and/or may at least partly include or be included in a combination of the above. Depending on the embodiment, modules in receiving system 120 may be concentrated in the same location, for example in one unit or in various units in proximity of one another, or modules of receiving system 120 may be dispersed over various locations.

Features of message managing system 140 when included in network 100 may vary depending on the embodiment. In some embodiments, part or all of message managing system 140 may at least partly include or be included in element(s) which service multiple user devices such as gateway(s), proxy server(s), other type(s) of server, etc. In some embodiments, part or all of message managing system 140 may at least partly include or be included in any system which provides web-based message management for a plurality of users, for instance a webmail provider system such as Yahoo®, Hotmail®, Gmail™, etc. Depending on the embodiment, modules in message managing system 140 may be concentrated in the same location, for example in one unit or in various units in proximity of one another, or modules of message managing system 140 may be dispersed over various locations. In embodiments where messages addressed to a receiving user are not managed by message managing system 140 (e.g. if use email application rather than webmail provider for email messages), network 100 does not necessarily include any message managing system 140.

Features of communication channel 130 may vary depending on the embodiment. For example, in various embodiments, there may be one or more communication channel(s) 130 between any pair of systems or parts thereof in network 100, and any communication channel 130 between any pair of systems or parts thereof in network 100 may comprise any suitable infrastructure for network 100 that provides direct or indirect connectivity between those two systems or parts thereof. It is noted that a communication channel between one pair of systems or parts thereof in network 100 may or may not be the same as a communication channel between another pair of systems or parts thereof in network 100. Communication channel 130 may use for example one or more wired and/or wireless technology/ies. Examples of channel 130 may include cellular network channel, personal area network channel, local area network channel, wide area network channel, internetwork channel, Internet channel, any combination of the above, etc.

In some embodiments, a particular location or locations may include a sending system such as system 110 and a receiving system such as system 120 which may or may not be integrated with one another. In these embodiments, the functionality of the particular location(s) with respect to sending and/or receiving may in some cases vary for different messages. In some embodiments, additionally or alternatively a specific location or locations may include only a sending system such as system 110 or only a receiving system such as system 120. In these embodiments, the message sending or receiving functionality of the specific location(s) may in some cases be consistent for all messages.

FIG. 3 is a block diagram of a system 300 for enhancing message list functionality, according to some embodiments of the presently disclosed subject matter. In the illustrated embodiments, system 300 includes one or more manipulator module(s) 320 configured to manipulate a graphical user interface. Optionally system 300 may include any of the following: one or more detector module(s) 310 configured to detect that a message in a message list has been indicated by a user performing a gesture on an input module; one or more input module(s) 330 configured to have a user indicate a message by performing a gesture thereon; one or more display module(s) 340 configured to display data to a user; one or more analyzer module(s) 350 configured to determine a message identifier by analyzing webpage(s) and/or communication(s) and/or configured to determine whether or not a message matches a criterion; one or more communicator module(s) 360 configured to communicate via communication channel 130, and/or one or more memory module(s) 370 configured to store message data such as data relating to message content. For simplicity of description, detector 310, manipulator 320, input 330, display 340, analyzer 350, communicator 360, and/or memory 370 are referred to below in the single form, but such reference should be construed to include embodiments with a single and/or a plural number of module(s), as appropriate for specific implementations and/or particular messages. When included, each of detector 310, manipulator 320, input 330, display 340, analyzer 350, communicator 360, and/or memory 370 may be made up of any combination of hardware, software and/or firmware capable of performing the operations as defined and explained herein. Examples of input 330 may include keyboard, mouse, camera, keypad, touch-screen display motion sensing input device (e.g. Kinect), etc. Examples of display 340 may include non-touch screen display, touch screen display, etc.

Embodiments of the subject matter do not limit the type of message list and a message list may refer to any list of messages which may be displayed to a user. Examples of message lists include (summary) inbox message list, sent message list, priority message list, message folder, deleted items folder, etc.

Depending on the embodiment, modules in system 300 may be concentrated in the same location, for instance in one unit or in various units in proximity of one another, or modules of system 300 may be dispersed over various locations.

In some cases, modules in system 300 may be included in (or in other words located at) receiving system 120 and/or message managing system 140, with any of the modules of system 300 included in any of the following element(s) which may at least partly comprise or be comprised in receiving system 120 and/or message managing system 140: a website; a web browser; a mail client (e.g. email client application, etc); an instant messaging client; any other type of Internet client; a peer-to-peer application; a user interface; an SMS application; an MMS application; a messaging application; a plug-in, an add-on, a toolbar or an applet for a browser, mail client, instant messaging client or any other application; a standalone client; any other suitable element servicing one user device; a gateway; a proxy server; any other type of server; a Web service, any other suitable element servicing multiple user devices; and/or an element with any other suitable configuration, etc.

In some cases, system 300 may comprise fewer, more, and/or different modules than those shown in FIG. 3. For instance in some of these cases, input 330 and display 340 may be integrated with one another. Additionally or alternatively, in some cases, the functionality of system 300 described herein may be divided differently among the modules of FIG. 3. Additionally or alternatively, in some cases, the functionality of system 300 described herein may be divided into fewer, more and/or different modules than shown in FIG. 3 and/or system 300 may in some cases include additional, less and/or different functionality than described herein.

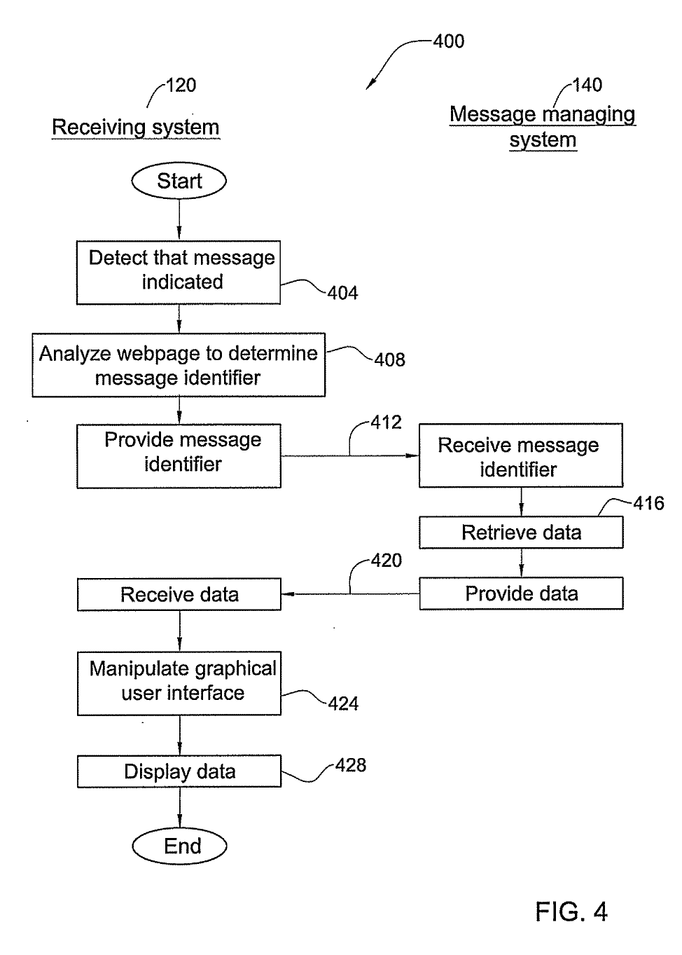

FIG. 4 is a flowchart illustration of a method 400 of enhancing message list functionality, according to some embodiments of the subject matter. Method 400 is performed by system 300 where various modules of system 300 are included in (or in other words located at) receiving system 120 and message managing system 140. Message managing system 140 provides web based message management services to a plurality of users including the user associated with receiving system 120. In some cases, method 400 may include fewer, more and/or different stages than illustrated in FIG. 4, the stages may be executed in a different order than shown in FIG. 4, stages that are illustrated as being executed sequentially may be executed in parallel and/or stages that are illustrated as being executed in parallel may be executed sequentially.

In the illustrated embodiments, in stage 404 system 300, for example detector 310 which in these embodiments is included in receiving system 120, detects that a user has indicated a certain message in a message list by performing a gesture on input 330 included in receiving system 120. The disclosure does not limit which gesture is performed, but for the sake of further illustration to the reader some examples are now presented. In some cases the performed gesture may have enabled a cursor and/or pointer associated with input 330 to remain on or near the message for a predefined amount of time. For instance, in some of these cases enabling a mouse-over may be a possible gesture. In some cases, the gesture may have enabled highlighting of the message. For instance, in some of these cases pressing on key(s) until the message is highlighted may be a possible gesture. In some cases, the gesture may include any physical movement of a body part of the user (e.g. finger movement, arm movement, etc). Since the indication of the message is what is detected, no selection of the message by the user is necessary for method 400 to proceed (e.g. no “click” on the message using a mouse, nor any other selection using any type of input 330 is necessary).

In the illustrated embodiments, in stage 408, system 300, for instance analyzer 350 which in these embodiments is included in receiving system 120, analyzes a webpage which includes the message list in order to determine the identifier of the indicated message.

In some of these embodiments, the analysis of the message list may include analyzing the contents of the web page which includes the message list in order to detect the message list. For instance, in order to help detect a list, receiving system 120 may first determine which domain (associated with a particular webmail provider, for example, Gmail™, Hotmail, YAHOO!®, etc) corresponds to message managing system 140 and then based on the determined domain, use an algorithm appropriate for that domain to detect the list. For example, the domain may be determined based on the URL of the web page, cookies, content of the web page and/or any other procedure. In some cases of these embodiments, the list of domains associated with webmail providers as well as the algorithm for analyzing the page contents may be updatable over network 100.

In some cases, the message identifier may be determined by system 300, for instance analyzer 350, monitoring the communication(s) between element(s) in receiving system 120 (e.g. web browser) and message managing system 140, in addition to or instead of by analyzing the webpage.

In some cases, system 300, for instance analyzer 350, may also determine whether or not the message matches a predetermined criterion, and if yes continue with method 400, but if not then end. For instance, the criterion may be at least partly based on a list of sender addresses or domains, meaning that method 400 may in this instance continue only if the message is from a sender address or domain on the list.

An example of pseudo code is now provided for stage 408 (with comments on the code in brackets). This example is one possible example of pseudo code for when message managing system 140 corresponds to Gmail webmail provider and the message list is a summary inbox list. Other examples may include less, more and/or different code lines. For instance, a code line presented below may be optional or omitted in another example, whereas in another instance, a different code line that does not appear below may be optional or mandatory.
Is the URL of the page of Gmail? If no, stop
Get Gmail user name by looking at the browser cookies and/or page content
Get all table elements in the page, and for each table, check if it contains certain HTML elements that exist only in a message list table
If such a table is found, then for the row corresponding to the indicated message get the data of the sender, subject and date by looking at the matching columns. (Algorithm knows which columns to look at because the algorithm knows the table structure, so the algorithm knows for example that the 3^{rd} column is that of the sender)
Is sender address or domain on list? If no, stop (This code line only included if there is such a matching criterion)
Obtain the unique message identifier in Gmail of the indicated message. (This may be done by analyzing the webpages and/or data flowing between the web browser and Gmail and extracting data sent from Gmail to the web browser that contains the message list as a data element, (such as a structure in JavaScript language). For some webmail providers, the message identifier may be included in the indicated message row)

In the illustrated embodiments in stage 412, assuming communicators 360 are included in both receiving system 120 and message managing system 140, communicator 360 in receiving system 120 communicates via communication channel 130 to communicator 360 in message managing system 140 providing the message identifier, which is received at message managing system 140.

In the illustrated embodiments in stage 416, data relating to the message content which was not visible when the user performed the gesture, is retrieved. For instance, data may be retrieved from memory 370 included in message managing system 140, and/or communicator 360 in message managing system 140 may retrieve data from third party/ies (e.g. from a third party web server). Possibly the provided message identifier may be used to identify data corresponding to the message.

In the illustrated embodiments, in stage 420, communicator 360 in message managing system 140 provides the retrieved data (relating to the message content and which was not visible when the user performed the gesture) via communication channel 130 to communicator 360 in receiving system 120. This data is received at communicator 360 of receiving system 120.

In some cases, data relating to message content and which was not visible when the user performed the gesture may have been previously cached, for instance when the message was previously indicated. In some of these cases, stages 412 and 420 may be omitted for the cached data if the cached data is useful; retrieval stage 416 may be performed for the cached data, if useful, by receiving system 120 instead with receiving system 120 retrieving cached data from memory included in receiving system 120. For instance, cached data may be identified by a cache key which is at least partly based on the message identifier. In some examples of these cases, any cached data may be considered useful. In other examples of these cases only if the cached data is fresh (e.g. less than a predetermined time period has lapsed since the cache entry was inserted to the cache, and/or the cached data is not expected to be frequently updated) would the cached data be considered useful. Additionally or alternatively, in various examples of these cases, cached data may be considered useful only if the indicated message was displayed in the same message list (e.g. summary inbox) when the data was cached, or cached data may be considered useful even if the indicated message was displayed in a different type of message list when the data was cached (e.g. in sent messages list rather than in summary inbox).

In some cases, data relating to message content and which was not visible when the user performed the gesture may be retrieved by communicator 360 in receiving system 120 from third party/ies (e.g. from a third party web server). Possibly the provided message identifier may be used to identify data corresponding to the message.

The disclosure does not impose limitations on which data relating to the message content and which was not visible when the user performed the gesture is retrieved (and/or provided and received). Therefore depending on the example, any data relating to the message content which was not visible when the user performed the gesture may be retrieved (and/or provided and received). However for the sake of further illustration to the reader some examples are now described. For instance, retrieved (and/or provided and received) data may include a more detailed message subject than was visible when the user performed the gesture. Additionally or alternatively, retrieved (and/or provided and received) data may include, for instance, the body of the message, or a part thereof (e.g. the first few lines). Additionally or alternatively, retrieved (and/or provided and received) data may include, for instance, one or more attachments to the message. Additionally or alternatively, retrieved (and/or provided and received) data may include, for instance, one or more names) of attachment(s) to the message. Additionally or alternatively, retrieved (and/or provided and received) data may include, for instance updated message content (e.g. from a third party such as the current offer of the day of an eCommerce webserver). Additionally or alternatively, retrieved (and/or provided and received) data may include, for instance, interactive message content (e.g. allowing interaction such as purchasing an item by clicking a button). Additionally or alternatively, retrieved (and/or provided and received) data may include, for instance, a visually enhanced message subject compared to the subject which was visible when the user performed the gesture (e.g. the visually enhanced message subject may include a visual directive such as HTML, color and/or font).

In the illustrated embodiments, in stage 424, system 300, for instance manipulator 320 which in these embodiments is included in receiving system 120, manipulates a graphical user interface whose content included the message list so as to enable retrieved (and/or provided and received) data which relates to content of the message and which was not visible when the user performed the gesture, to be displayed to the user. For instance, the manipulation may include inserting one or more graphical user interface element(s) and/or modifying the content of one or more existing graphical user interface element(s). In some cases of this instance where manipulator 320 inserts one or more graphical user interface element(s), the content of the inserted element(s) may include at least part of the retrieved (and/or provided and received) data. Examples of inserted graphical user interface element(s) may include, inter-alia: one or more pop-up window(s), one or more overlay graphical user interface element(s) such as floating overlay graphical user interface element(s), and/or one or more newly created preview section(s). In some cases of this instance where manipulator 320 additionally or alternatively modifies the content of one or more existing graphical user interface element(s), the modified content may include at least part of the retrieved, (and/or provided and received) data. Examples of existing graphical user interface element(s) may include inter-alia: the message list area and/or one or more existing preview section(s).

Depending on the embodiment, data which relates to content of the message and which was not visible when the user performed the gesture may or may not be juxtaposed with other data in a graphical user interface (after manipulation). For instance, a pop-up, preview section, overlay element, or message list area may include both data which relates to content of the message and which was not visible when the user performed the gesture as well as other data, or may only include one or the other.

In the illustrated embodiments, in stage 428, system 300, for instance display 340 included in receiving system 120 displays retrieved (and/or provided and received) data which relates to content of the message and which was not visible when the user performed the gesture. For instance, depending on how the graphical user interface was manipulated in stage 424, data which relates to the content of the message and which was not visible when the user performed the gesture may be displayed in one or more pop-up window(s), in one or more overlay graphical user interface element(s) such as floating overlay graphical user interface element(s), in one or more newly created preview section(s), in the message list area, in one or more existing preview section(s), and/or in any other existing and/or inserted graphical user interface element(s).

Depending on the embodiment, all retrieved (and/or provided and received) data may be displayed or not all may necessarily be displayed. Depending on the embodiment, retrieved (and/or provided and received) data may only include data relating to content of the message which was not visible when the user performed the gesture, or may also include other data.

In some cases where data was received by receiving system 120 from message managing system 140 and/or retrieved by receiving system 120 from third party/ies, at least part of this data may be cached in memory 370 included in receiving system 120. In these cases, if the same message is again indicated, cached data may possibly be retrieved from memory 370 included in receiving system 120. For instance, cached data may be identified by a cache key which is at least partly based on the message identifier. In other cases, data from message managing system 140 and/or third party/ies may not be cached. In still other cases, data from message managing system 140 and/or third party/ies may sometimes be cached and sometimes not with the decision of whether or not to cache dependent on any suitable factor(s). Examples of factors which may affect the decision may include inter-alia: amount of time to cache and retrieve from cache versus amount of time to receive from message managing system 140 and/or retrieve from third party/ies, identity of sending user, amount of data, type of data (e.g. frequently updated data may be less likely to be cached than not frequently updated data in some instances), amount of space available in cache, configuration of receiving system 120 etc. In some embodiments caching may increase responsiveness, decrease the load on network 100, and/or facilitate communication but in other embodiments caching may not necessarily provide these advantages. Depending on the embodiment, if data is cached the caching may be for a limited time period, after which the cached result may be deleted from the cache, or there may be no time limitation.

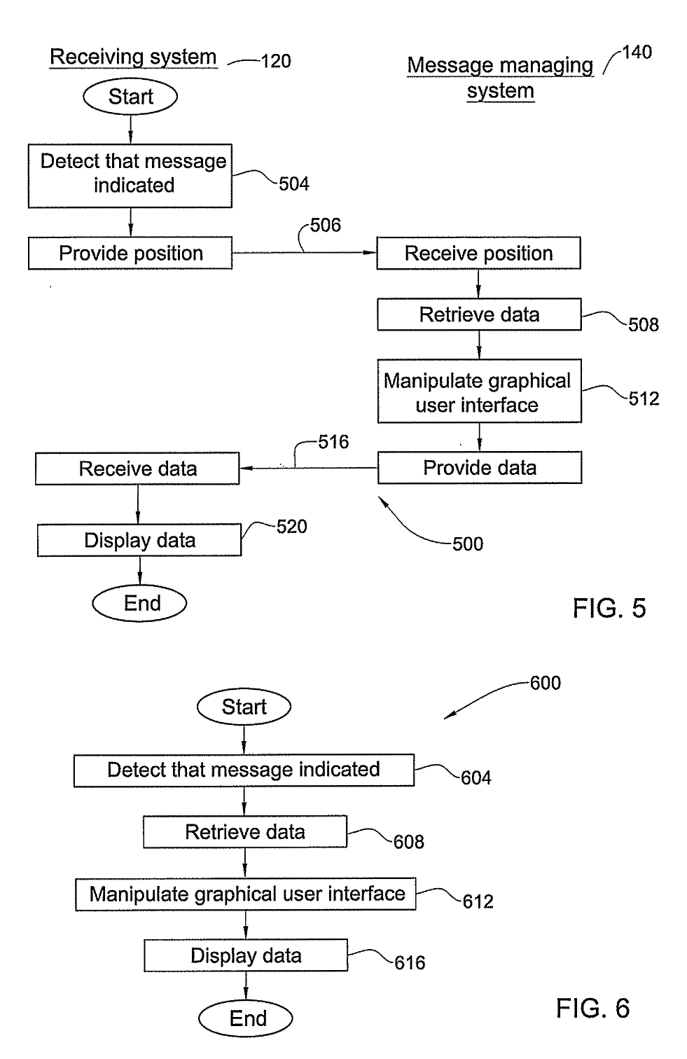

FIG. 5 is a flowchart illustration of a method 500 of enhancing message list functionality, according to some embodiments of the subject matter. Method 500 is performed by system 300 where various modules of system 300 are included in (or in other words located at) receiving system 120 and message managing system 140. Message managing system 140 provides web based message management services to a plurality of users including the user associated with receiving system 120. In some cases, method 500 may include fewer, more and/or different stages than illustrated in FIG. 5, the stages may be executed in a different order than shown in FIG. 5, stages that are illustrated as being executed sequentially may be executed in parallel and/or stages that are illustrated as being executed in parallel may be executed sequentially.

In the illustrated embodiments, in stage 504 system 300, for example detector 310 which in these embodiments is included in receiving system 120, detects that a user has indicated a certain message in a message list by performing a gesture on input 330 included in receiving system 120. The disclosure does not limit which gesture is performed, but for the sake of further illustration to the reader some examples are now presented. In some cases the performed gesture may have enabled a cursor and/or pointer associated with input 330 to remain on or near the message for a predefined amount of time. For instance, in some of these cases enabling a mouse-over may be a possible gesture. In some cases, the gesture may have enabled highlighting of the message. For instance, in some of these eases pressing on key(s) until the message is highlighted may be a possible gesture. In some cases, the gesture may include any physical movement of a body part of a user (e.g. finger movement, arm movement, etc). Since the indication of the message is what is detected, no selection of the message by the user is necessary for method 500 to proceed (e.g. no “click” on the message using a mouse, nor any other selection using any type of input 330 is necessarily required).

In the illustrated embodiments in stage 506, assuming communicators 360 are included in both receiving system 120 and message managing system 140, communicator 360 in receiving system 120 communicates via communication channel 130 to communicator 360 in message managing system 140 providing position data, which is received at message managing system 140. Based at least partly on the received position data, specifying the position of the indicated message in the list, message managing system 140 may determine which message has been indicated.

In some cases, instead of or in addition to position data, communicator 360 in receiving system 120 may communicate via communication channel 130 to communicator 360 in message managing system 140 some or all of the data displayed in the message list for the indicated message. For instance, in some of these cases, the webpage may be analyzed (e.g. by analyzer 350 included in receiving system 120) in order to detect the message list and the row in the message list corresponding to the indicated message (e.g. as described above with respect to stage 408) so that data on the indicated message may be provided to message managing system 140. Based at least partly on the received data, message managing system 140 may determine which message has been indicated.

In some cases, system 300 for instance analyzer 350 which in these cases is included in message managing system 140 may determine whether or not the indicated message matches a predetermined criterion, and if yes continue with method 500, but if not then end. For instance, the criterion may be at least partly based on a list of sender addresses or domains, meaning that method 500 may in this instance continue only if the message is from a sender address or domain on the list.

In the illustrated embodiments in stage 508, data relating to the message content which was not visible when the user performed the gesture, is retrieved. For instance, data may be retrieved from memory 370 included in message managing system 140, and/or communicator 360 in message managing system 140 may retrieve data from a third party/ies (e.g. from a third party web server). It is noted that the message identifier of the indicated message is typically known to message managing system 140 and therefore the message identifier may possibly be used to identify data corresponding to the message.

The disclosure does not impose limitations on which data relating to the message content and which was not visible when the user performed the gesture is retrieved. Therefore depending on the example, any data relating to the message content and which was not visible when the user performed the gesture may be retrieved. However for the sake of further illustration to the reader some examples are now described. For instance, retrieved data may include a more detailed message subject than was visible when the user performed the gesture. Additionally or alternatively, retrieved data may include, for instance, the body of the message, or a part thereof (e.g. the first few lines). Additionally or alternatively, retrieved data may include, for instance, one or more attachments to the message. Additionally or alternatively, retrieved data may include, for instance, one or more name(s) of attachment(s) to the message. Additionally or alternatively, retrieved data may include, for instance updated message content (e.g. from a third party such as current offer of the day of an eCommerce webserver). Additionally or alternatively, retrieved data may include, for instance, interactive message content (e.g. allowing interaction such as purchasing an item by clicking a button). Additionally or alternatively, retrieved data may include, for instance, a visually enhanced message subject compared to the subject which was visible when the user performed the gesture (e.g. the visually enhanced message subject may include a visual directive such as HTML, color and/or font).

In the illustrated embodiments, in stage 512, system 300, for instance manipulator 320 which in these embodiments is included in message managing system 140 manipulates a graphical user interface whose content included the message list so as to enable retrieved data which relates to the content of the message and which was not visible when the user performed the gesture, to be displayed to the user. For instance, the manipulation may include inserting one or more graphical user interface element(s) and/or modifying the content of one or more existing graphical user interface element(s). In some cases of this instance where manipulator 320 inserts one or more graphical user interface element(s), the content of the inserted element(s) may include at least part of the retrieved data. Examples of inserted graphical user interface element(s) may include, inter-alia: one or more pop-up window(s), one or more overlay graphical user interface element(s) such as floating overlay graphical user interface element(s), and/or one or more newly created preview section(s). In some cases of this instance where manipulator 320 additionally or alternatively modifies the content of one or more existing graphical user interface element(s), the modified content may include at least part of the retrieved data. Examples of existing graphical user interface element(s) may include, inter-alia: the message list area and/or one or more existing preview section(s).

Depending on the embodiment, data which relates to content of the message and which was not visible when the user performed the gesture may or may not be juxtaposed with other data in a graphical user interface (after manipulation). For instance, a pop-up, preview section, overlay element, or message list area may include both data which relates to content of the message and which was not visible when the user performed the gesture as well as other data, or may only include one or the other.

In the illustrated embodiments, in stage 516, communicator 360 in message managing system 140 provides retrieved data (relating to the message content and which was not visible when the user performed the gesture) via communication channel 130 to communicator 360 in receiving system 120. This provided data is received at communicator 360 of receiving system 120. For instance, communicator 360 in message managing system 140 may provide a graphical user interface (after manipulation in stage 512 so as to enable display of retrieved data) to communicator 360 in receiving system 120.

In the illustrated embodiments, in stage 520, system 300, for instance display 340 included in receiving system 120, displays data received in stage 516 which relates to the content of the message and which was not visible when the user performed the gesture. For instance, depending on how the graphical user interface was manipulated in stage 512, data which relates to the content of the message and which was not visible when the user performed the gesture may be displayed in one or more pop-up window(s), in one or more overlay graphical user interface element(s) such as floating overlay graphical user interface element(s), in one or more newly created preview section(s), in the message list area, in one or more existing preview section(s), and/or in any other existing and/or inserted graphical user interface element(s).

Depending on the embodiment, all data received in stage 516 may be displayed or not all may necessarily be displayed. Depending on the embodiment, data received in stage 516 may only include data relating to content of the message which was not visible when the user performed the gesture, or may also include other data.

FIG. 6 is a flowchart illustration of a method 600 of enhancing message list functionality, according to some embodiments of the subject matter. Method 600 is performed by system 300 where modules of system 300 are included in (or in other words located at) receiving system 120 which receives messages for the user (e.g. by way of an email client application) without having as an intermediary a message managing system such as message managing system 140. In some cases, method 600 may include fewer, more and/or different stages than illustrated in FIG. 6, the stages may be executed in a different order than shown in FIG. 6, stages that are illustrated as being executed sequentially may be executed in parallel and/or stages that are illustrated as being executed in parallel may be executed sequentially.

In the illustrated embodiments, in stage 604 system 300, for example detector 310, detects that a user has indicated a certain message in a message list by performing a gesture on input 330. The disclosure does not limit which gesture is performed, but for the sake of further illustration to the reader some examples are now presented. In some cases the performed gesture may have enabled a cursor and/or pointer associated with input 330 to remain on or near the message for a predefined amount of time. For instance, in some of these cases enabling a mouse-over may be a possible gesture. In some cases, the gesture may have enabled highlighting of the message. For instance, in some of these cases pressing on key(s) until the message is highlighted may be a possible gesture. In some cases, the gesture may include any physical movement of a body part of the user (e.g. finger movement, arm movement, etc.) Since the indication of the message is what is detected, no selection of the message by the user is necessary for method 600 to proceed (e.g. no “click” on the message using a mouse, nor any other selection using any type of input 330 is necessary).

In some cases, system 300, for instance analyzer 350, may determine whether or not the indicated message matches a predetermined criterion, and if yes continue with method 600, but if not then end. For instance, the criterion may be at least partly based on a list of sender addresses or domains, meaning that method 600 may in this instance continue only if the message is from a sender address or domain on the list.

In the illustrated embodiments in stage 608, data relating to the message content which was not visible when the user performed the gesture, is retrieved. For instance, data may be retrieved from memory 370, and/or communicator 360 may retrieve data from third party/ies (e.g. from a third party web server). It is noted that the message identifier of the indicated message is typically known to receiving system 120 and therefore the message identifier may possibly be used to identify data corresponding to the message.

The disclosure does not impose limitations on which data, relating to the message content and which was not visible when the user performed the gesture, is retrieved. Therefore depending on the example, any data relating to the message content and which was not visible when the user performed the gesture may be retrieved. However for the sake of further illustration to the reader some examples are now described. For instance, retrieved data may include a more detailed message subject than was visible when the user performed the gesture. Additionally or alternatively, retrieved data may include, for instance, the body of the message, or a part thereof (e.g. the first few lines). Additionally or alternatively, retrieved data may include, for instance, one or more attachments to the message. Additionally or alternatively, retrieved data may include, for instance, one or more name(s) of attachment(s) to the message. Additionally or alternatively, retrieved data may include, for instance updated message content (e.g. from a third party such as the current offer of the day of an eCommerce webserver). Additionally or alternatively, retrieved data may include, for instance, interactive message content (e.g. allowing interaction such as purchasing an item by clicking a button). Additionally or alternatively, retrieved data may include, for instance, a visually enhanced message subject compared to the subject which was visible when the user performed the gesture (e.g. the visually enhanced message subject may include a visual directive such as HTML, color and/or font).

In the illustrated embodiments, in stage 612, system 300, for instance manipulator 320 manipulates a graphical user interface whose content included the message list so as to enable retrieved data which relates to the content of the message and which was not visible when the user performed the gesture, to be displayed to the user. For instance, the manipulation may include inserting one or more graphical user interface element(s) and/or modifying the content of one or more existing graphical user interface element(s). In some cases of this instance where manipulator 320 inserts one or more graphical user interface element(s), the content of the inserted element(s) may include at least part of the retrieved data. Examples of inserted graphical user interface element(s) may include, inter-alia: one or more pop-up window(s), one or more overlay graphical user interface element(s) such as floating overlay graphical user interface element(s), and/or one or more newly created preview section(s). In some cases of this instance where manipulator 320 additionally or alternatively modifies the content of one or more existing graphical user interface element(s), the modified content may include at least part of the retrieved data. Examples of existing graphical user interface element(s) may include, inter-alia: the message list area and/or one or more existing preview section(s).

Depending on the embodiment, data which relates to content of the message and which was not visible when the user performed the gesture may or may not be juxtaposed with other data in a graphical user interface (after manipulation). For instance, a pop-up, preview section, overlay element, or message list area may include both data which relates to content of the message and which was not visible when the user performed the gesture as well as other data, or may only include one or the other.

In the illustrated embodiments, in stage 616, system 300, for instance display 340 displays retrieved data which relates to content of the message and which was not visible when the user performed the gesture. For instance, depending on how the graphical user interface was manipulated in stage 612, retrieved data may be displayed in one or more pop-up window(s), in one or more overlay graphical user interface element(s) such as floating overlay graphical user interface element(s), in one or more newly created preview section(s), in the message list area, in one or more existing preview section(s), and/or in any other existing and/or inserted graphical user interface element(s).

Depending on the embodiment, all retrieved data may be displayed or not all may necessarily be displayed. Depending on the embodiment, retrieved data may only include data relating to content of the message which was not visible when the user performed the gesture, or may also include other data.

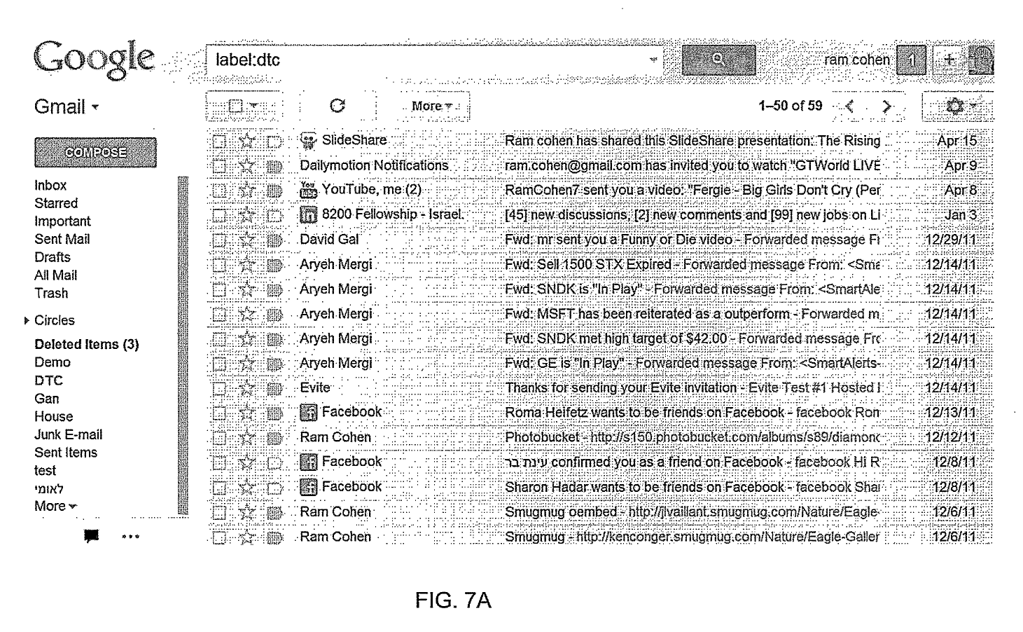

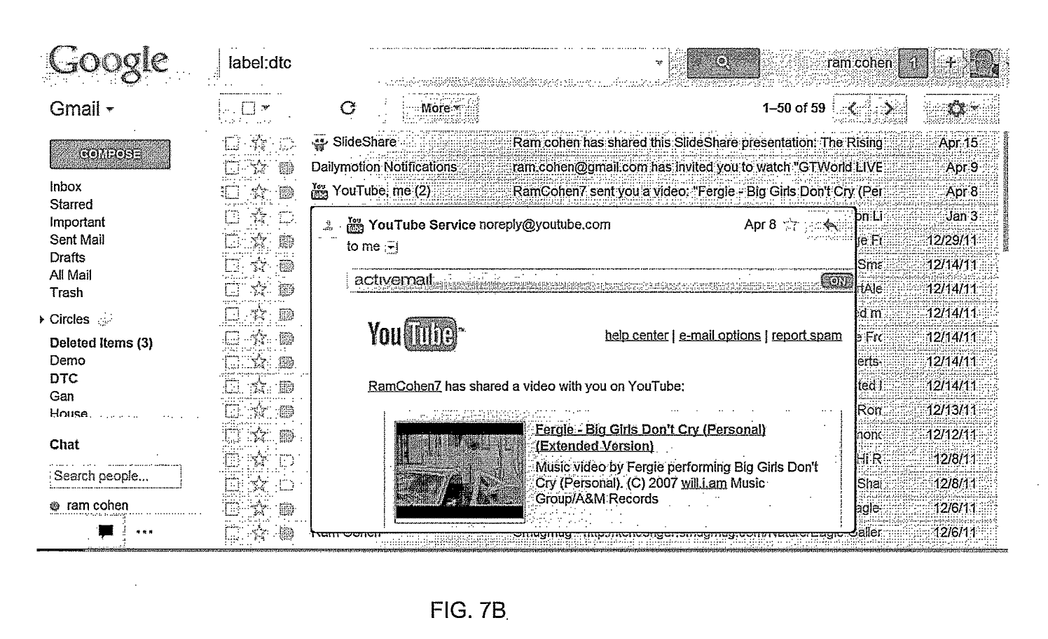

The subject matter does not limit the content, format and layout of what is displayed prior to a user performing the gesture on an input device. Neither does the subject matter limit the content, format, and layout of what is displayed after a message in a message list has been indicated by a user performing the gesture on an input device. In any of the embodiments described above what is displayed may have any appropriate content, format or layout. However for the sake of further illustration to the reader, two possible screenshots are included in the disclosure. FIG. 7A is screenshot of a Gmail message list before a user performs a gesture on an input device, according to some embodiments of the subject matter. FIG. 7B is screenshot of what is displayed after a user indicated a message in a Gmail message list by performing a gesture on an input device, according to some embodiments of the subject matter.

Comparing the screenshot of FIG. 7B to the screenshot of FIG. 7A it is noted that the screenshot of FIG. 7B also includes an overlay graphical user interface element. The content of the overlay element includes part of the body of the message from the YouTube Service as well as interactive message content (e.g. the video).

It will also be understood that some embodiments contemplate a computer program being readable by a computer for executing a method or part of a method disclosed herein. Some embodiments further contemplate a computer-readable medium tangibly embodying program code readable by a computer for executing a method or part of a method disclosed herein.

While embodiments of the subject matter have been shown and described, the subject matter is not thus limited. Numerous modifications, changes and improvements within the scope of the subject matter will now occur to the reader.

1. A method, comprising:
after a message in a message list has been indicated by a user performing a gesture on an input module, manipulating a graphical user interface whose content included said message list so as to enable data which relates to content of said message and which was not visible when said user performed said gesture to be displayed to said user.

2. The method of claim 1, wherein said manipulating includes: inserting in said graphical user interface at least one graphical user interface element whose content includes data which relates to content of said message and which was not visible when said user performed said gesture.

3. The method of claim 2, wherein said at least one graphical user interface element includes at least one selected from a group comprising: pop-up window, overlay graphical user interface element, or preview section.

4. The method of claim 1, wherein said manipulating includes: modifying content of at least one existing graphical user interface element in said graphical user interface so as to include data which relates to content of said message and which was not visible when said user performed said gesture.

5. The method of claim 4, wherein said at least one existing graphical user interface element includes at least one selected from a group comprising: message list area or existing preview section.

6. The method of claim 1, wherein said data which relates to content of said message includes at least one selected from a group comprising: a more detailed message subject than visible when said user performed said gesture, body of said message, part of a body of said message, at least one attachment to said message, at least one name of attachment to said message, updated message content, interactive message content, or a visually enhanced message subject.

7. The method of claim 1, further comprising: displaying to said user data which relates to content of said message and which was not visible when said user performed said gesture.

8. The method of claim 1, wherein said message list is included in a webpage, further comprising:
analyzing said webpage in order to determine an identifier of said message;
providing said identifier to a message managing system associated with said webpage; and
receiving from said message managing system data which relates to content of said message and which was not visible when said user performed said gesture.

9. The method of claim 1, further comprising:
determining whether or not said message matches a predetermined criterion;
wherein only if said message matches a predetermined criterion, said manipulating occurs, but if said message does not match a predetermined criterion then said manipulating does not occur.

10. A system, comprising:
a manipulator capable of manipulating a graphical user interface whose content included a message list, after a message on said message list has been indicated by a user performing a gesture on an input module, so as to enable data which relates to content of said message and which was not visible when said user performed said gesture to be displayed to said user.

11. The system of claim 10, further comprising:
a display capable of displaying to said user data which relates to content of said message and which was not visible when said user performed said gesture.

12. The system of claim 10, further comprising:
a detector capable of detecting that a message in a message list has been indicated by said user performing said gesture.

13. The system of claim 10, further comprising:
an input capable of having said user indicate said message by performing a gesture thereon.

14. The system of claim 10, further comprising:
a memory capable of storing data which relates to content of said message and which was not visible when said user performed said gesture.

15. The system of claim 10, further comprising:
an analyzer capable of analyzing a webpage which included said message list in order to determine an identifier of said message.

16. The system of claim 10, further capable of determining whether or not said message matches a predetermined criterion, wherein only if said message matches a predetermined criterion, said manipulating occurs, but if said message does not match a predetermined criterion then said manipulating does not occur.

17. The system of claim 10, wherein said system is a receiving system.

18. The system of claim 10, wherein said system is a message managing system capable of providing web-based message management to a plurality of users including said user.

19. The system of claim 10, wherein said system includes a receiving system and a message managing system capable of providing web-based message management to a plurality of users including said user.

20. The system of claim 10, wherein said system is included in at least one selected from a group comprising: a web site, a web browser, an instant messaging client, a peer to peer application, a user interface, an SMS application, an MMS application, a messaging application, any other type of Internet client, a plug-in add-on toolbar or applet for a web browser mail client instant messaging client or any other application, a standalone client, any other element servicing one user device, a gateway, a proxy server, any other type of server, a Web service, any other element servicing multiple user devices, or an element with any other suitable configuration.

21. A computer program product comprising a computer useable medium having computer readable program code embodied therein, the computer program product comprising:
computer readable program code for causing the computer, after a message in a message list has been indicated by a user performing a gesture on an input module, to manipulate a graphical user interface whose content included said message list so as to enable data which relates to content of said message and which was not visible when said user performed said gesture to be displayed to said user.
